(19) United States
(12) Patent Application Publication
(10) Pub. No.: US 2015/0308094 A1
(43) Pub. Date: Oct. 29, 2015

(54) SYSTEM AND CONTROL FOR GREASE REMOVAL

(71) Applicant: Thermaco, Inc., Asheboro, NC (US)

(72) Inventors: Randolph Batten, Asheboro, NC (US); William C. Batten, Asheboro, NC (US); Bruce W. Kyles, Asheboro, NC (US)

(73) Assignee: Thermaco, Inc., Asheboro, NC (US)

(21) Appl. No.: 14/628,977

(22) Filed: Feb. 23, 2015

Related U.S. Application Data
(60) Provisional application No. 61/942,634, filed on Feb. 21, 2014.

(51) Int. Cl. E03F 5/16; B01D 17/02

(52) U.S. Cl. CPC E03F 5/16; B01D 17/0214

(57) ABSTRACT

A separator and method of its use for separating oil, grease F.O.G. from effluent has a control to avoid potential user errors. A skimming control causes skimming events to occur in accordance with presets that include a preset minimum skim setting above zero, a preset maximum skim setting below a continuous skim event. A user interface allows the user to select a user skim mode. The user skim mode settings include a programming cycle that directs a series of skimming events to occur at substantially non-repetitive times during a skimming event cycle.

### BACKGROUND OF THE INVENTION

Oil, grease and solid waste contaminant removal or recovery systems are well known in the prior art. Over the past thirty years there has been a steady move towards requiring food handling facilities to have systems for servicing kitchen grease and solid waste bearing water flows. Sewer system lines can become clogged from the fats, oil and grease waste materials (hereinafter referred to as “F.O.G.”) put into the sewer system from food handling facilities. This has led more and more sewer authorities to implement fats, oils and grease control programs. These programs regulate food handling facilities and the manner in which they process F.O.G.s. The object of many of these programs is to ensure that food handling facilities remove as much of the F.O.G. as possible from the effluent flow, thereby releasing only grey water to the sewer system.

Active separators remove F.O.G. from the effluent, typically by some skimming operation. This skimming operation is generally accomplished through use of a container including one or more rotating disks formed of a plastic or like applicable material to which oil and grease contaminants are attracted. Typically, the rotation of the disk is in an at least partially immersed condition, which allows the oil to cling to one or both sides of the disk so that F.O.G. contaminants are removed from the body of water upon rotation of the disk. Scrapers are typically used to force the oil contaminants from the opposite sides of the disk and channel such contaminants to a collection or disposal storage unit.

Skimming when skimming is required and not skimming when it is not required is an issue that has not yet been precisely addressed by the art. The traditional methodology is simply to use a timer that turns on the skimming apparatus at a certain standard time of day, at the same time each day, providing the user with control as to the time of day, regardless of skimming facility needs. For installations that have very regular schedules, this may be sufficient. However, most installations operate on irregular schedules and problems can arise. Schedule variations can be as simple as the differences between weekday and weekend operation. Also, for installations such as school cafeterias that do not operate during the summer, F.O.G. will not be added to the effluent during the summer, so there is not a reason to run the separator during the summer. Nonetheless, if the separator works on a regular set schedule according to its timer, it will run even if there is no F.O.G. to be removed.

One of the downsides of this operation, besides the wasted energy of skimmer operation, is that when all of the F.O.G. is removed, the water becomes exposed. There may be food solids remaining in the water that are decomposing and off-gassing foul odors. While the purpose of a F.O.G. removal system is to remove F.O.G. from the effluent, if a slight F.O.G. mat is allowed to remain on the water, the odor is more contained within the water. Therefore, removing as much F.O.G. as possible may not be the most desirable in some instances. Installations commonly discharge gray water taken from a low point of the container, so allowing a thin F.O.G. mat to remain on the surface well above that point does not usually result in the FO.G. discharging with the gray water.

Another challenge is that humidity emanating from the water can rise into the electronics and shorten the longevity of the electronics. Additionally, the process of skimming may stir up the stored contents and actually increase the noticeability of odors associated with F.O.G. removal, especially when the skimming occurs at the same time on the same days by regular scheduling. When that happens, kitchen stuff may become incented to disable operation of the F.O.G. removal device.

Accordingly, there is a need in the art for an improved control for a F.O.G. removal assembly for the removal and recovery of F.O.G. and/or solid wastes found in drains or effluent discharge of restaurants, food processing, or like facilities, industrial plants, maintenance facilities, or other circumstances involving mixtures of oil, grease and solid waste material to be recovered or removed.

### SUMMARY OF THE INVENTION

The present invention fulfills one or more of these needs by providing an improved control for an oil, grease and solid waste removal assembly which is reliable and diminishes the unsavory aspects associated with removal of F.O.G.

In one example, a separator for separating F.O.G. and/or solids from effluent includes a container with a cover for receiving and holding effluent water containing fat, oil, grease and/or solid waste to be removed from the effluent water; at least one rotatable disk supported within the container in a partially immersed position within the body of effluent water and in contact with the oil and grease; a drive in driving engagement to provide rotation of the disk when the drive is engaged; a trough in engaging relation to opposite sides of the rotatable disk; and a scraper blade mounted on the trough so that the scraper blade extends from the trough into sliding engagement with a side of the disk. Generally, the disk, scraper blade and trough are cooperatively disposed and structured to direct oil and grease from the disk along the scraper blade along the trough for collection in a storage container. The separator also includes a skimming control that controls when the drive activates rotation of the disk to skim F.O.G. from the effluent. The skimming control includes a preset minimum skim setting above zero, a preset maximum skim setting below a continuous rotation of the disk, and a user interface that allows the user to select a skim mode setting between the preset minimum skim setting and the preset maximum skim setting.

In another mode, the control does not effectively skim, but exercises the motor driving the disk, for a brief period on the order of about five (5) seconds.

The control can include a communications capability, such as a cellular or Wi-Fi connection, and or a GPS module to let a central office monitor the operation and know the whereabouts of the separator.

In another example, a skimmer control system for a F.O.G. separator that removes F.O.G. from effluent includes a skimming control that controls when the drive activates rotation of the disk to skim F.O.G. from the effluent. The skimming control includes a preset minimum skim setting above zero, a preset maximum skim setting below a continuous rotation of the disk, and a user interface that allows the user to select a user skim mode setting between the preset minimum skim setting and the preset maximum skim setting. The user skim mode settings include a programming cycle that directs a series of skimming events to occur at substantially non-repetitive times during a skimming event cycle.

The present disclosure also includes a method of controlling removal of F.O.G and/or solid waste material from effluent water. Further, a method of making a F.O.G. removal assembly is described and disclosed.

### BRIEF DESCRIPTION OF THE DRAWINGS

The invention will be better understood by a reading of the Detailed Description of the Preferred Embodiments along with a review of the drawings, in which:

FIG. 1 is a perspective view of one example of a separator assembly according to the present disclosure;

FIG. 2 is a perspective view of one example of a container with a basket support and an outlet baffle installed;

FIG. 3 is a perspective view of one example of a basket support;

FIG. 4 is a perspective view of one example of an outlet baffle;

FIG. 5 is a perspective view of one example of a container and a wrap;

FIG. 6 is a perspective view of one example of a cover with a gear drive motor, a disk, and a trough;

FIG. 6A is a perspective side view of one example of a cover with a gear drive motor, a disk, a trough and a timer;

FIG. 7 is a top perspective view of one example of a cover with a gear drive motor, a disk, and a trough;

FIG. 7A is a bottom perspective view of one example of a cover with a disk and a heating element;

FIG. 8 is perspective view of one example of an oil, grease and solid removal assembly including a cover;

FIG. 9 is a perspective view of one example of a user interface according to the present disclosure;

FIG. 10 is an exploded view of one example of a user interface;

FIG. 11 is a schematic showing Skim Time versus Skim Time Delay ratios for various grease generation facility levels;

FIG. 12 is a perspective view of one example of a skimmer control according to the present disclosure;

FIG. 13 is a front perspective view of one example of a skimmer control according to the present disclosure; and

FIG. 14 is a block diagram of a skimmer control including a communications module and GPS.

### DESCRIPTION OF THE PREFERRED EMBODIMENTS

In the following description, like reference characters designate like or corresponding parts throughout the several figures. It should be understood that the illustrations are for the purpose of describing preferred embodiments of the invention and are not intended to limit the invention thereto.

Applicant realized that there were challenges with electromechanical timers associated with F.O.G. separators that regulate F.O.G. separating schedules. For example, electromechanical timers often allow users almost complete manual control of the F.O.G. separation schedules, allowing the programming of excessively long or frequent separation events and/or forgetting to schedule F.O.G. separation events. Regulations often require facilities to incorporate F.O.G. separation units to reduce the amount of grease released into the sewage systems; however, each facility varies in the amount of F.O.G. produced, therefore, varying the skimming needs from site to site. Personnel with access to the controls of such a F.O.G. separation unit may not be educated in the skimming cycles of the unit. For example, a F.O.G. separation system may be installed at a facility with a relatively low production of grease, and yet if personnel detect an odor and associate it with the F.O.G. removal system, they may set the system to skim even more often, not realizing that an overly aggressive skim schedule may actually intensify the unpleasant odor. As a result, in this example, the F.O.G. removal system is manually set to run at an even more aggressive pace, not solving the problem and unnecessarily contributing to wear on the system and potentially decreasing the longevity of the system.

Also, conventional sensor controls that “sense” when skimming is needed do not offer optimal regulation of separation events, often do not work reliably, and often eliminate user input and control altogether. This type of skimming control relies heavily on the proper functioning of the sensors. Applicant has found that users typically dislike a preset F.O.G. cycle that offers them no control over the skimming cycle, particularly when F.O.G. output varies between facilities. Applicant's invention addresses these and other issues with F.O.G. separation and system controls.

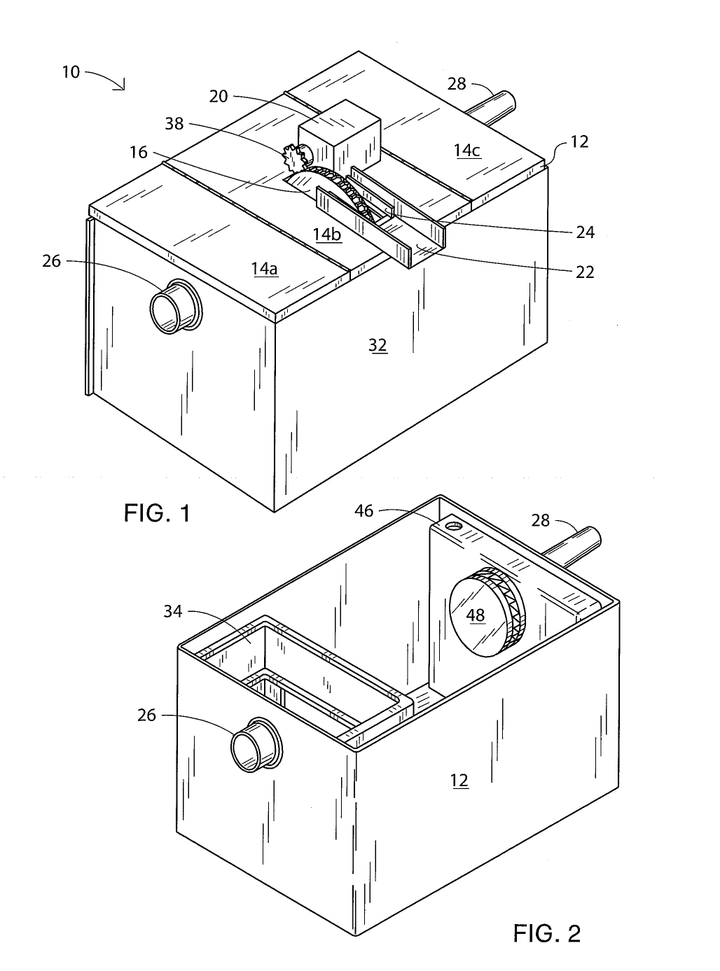

In one example, as best seen in FIGS. 1, 2 and 3, a F.O.G. separator assembly 10 includes a container 12. The container 12 may include sectional covers 14a, 14b, and 14c. In one example, as in FIG. 1, the sectional covers are joined by hinges. The cover can be made up of sectional units or a single-unit cover. The sectional covers 14a, 14b and 14c cover each of the sections of the F.O.G. and/or solid waste removal assembly and may be one piece, attached or separate. The assembly 10 has at least one skimmer assembly. In one example, the skimmer assembly includes a rotatable disk 16 which may be supported, as shown, by the center sectional cover 14b. FIG. 1 shows a gear drive motor 20 and a trough 22 which may be attached to the cover 14b. The container 12 also includes an inlet pipe 26 and an outlet pipe 28. The effluent water, with waste materials, enters through the inlet pipe 26, and after oil, grease and solid waste have been removed, the grey water exits out of the outlet pipe 28. The trough 22 may include scraper blades 24. In this example, the gear drive motor 20 typically supports and rotates a drive sprocket 38 which is cooperatively meshed with peripheral holes in the disk 16.

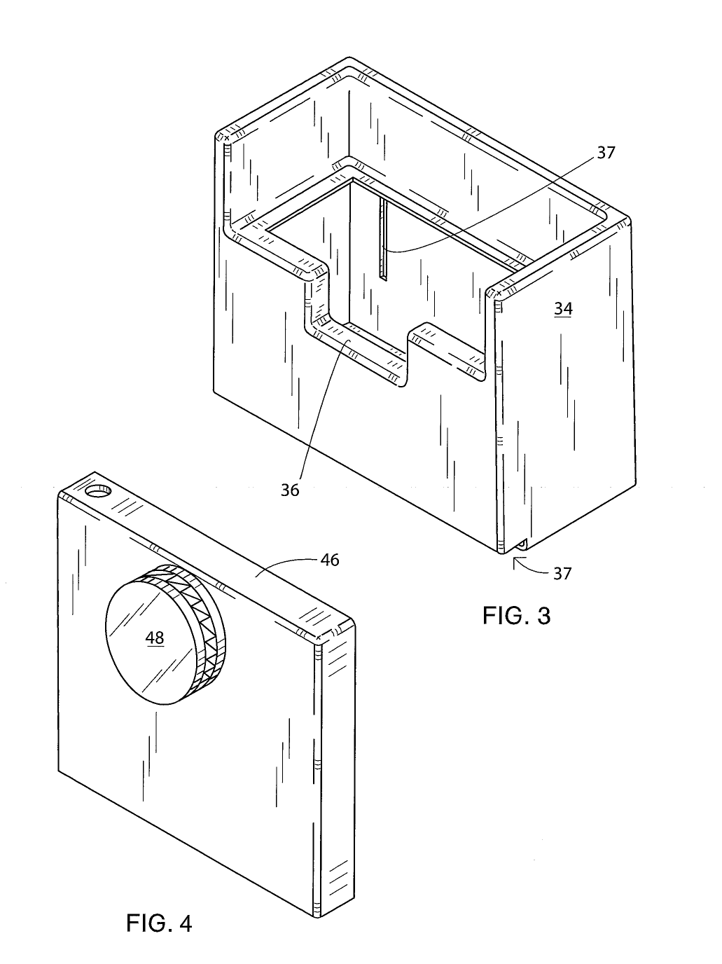

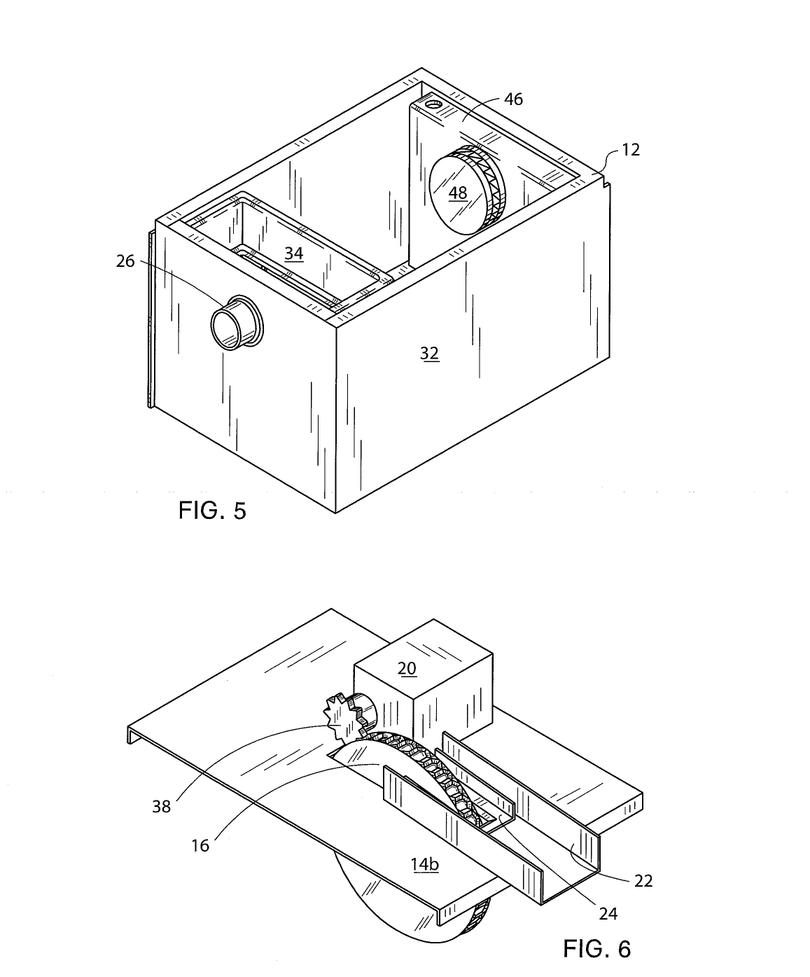

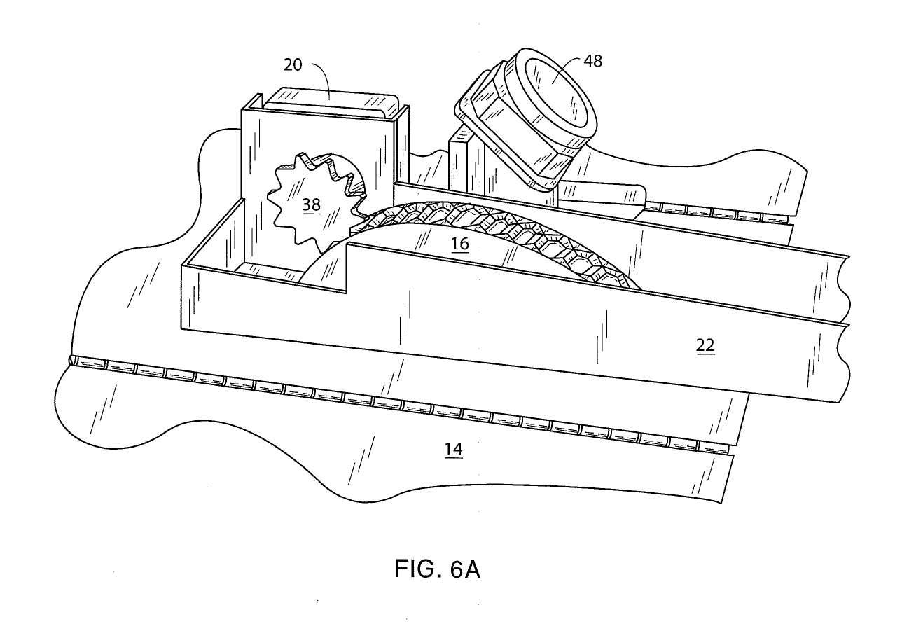

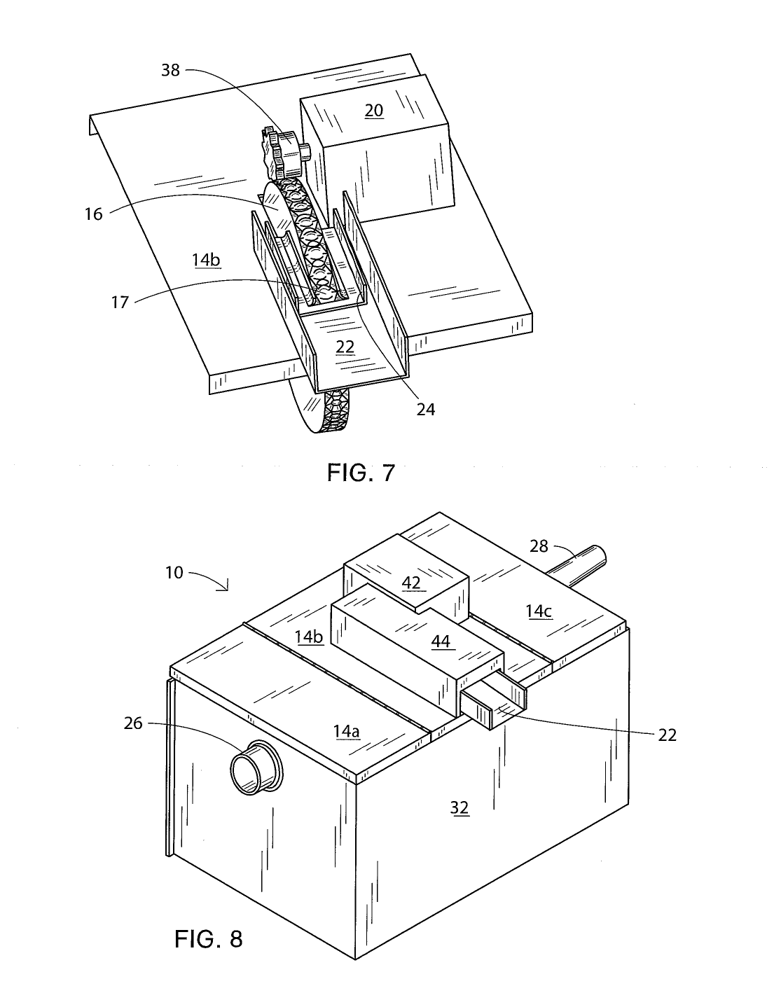

Container 12 may be constructed of rotomolded plastic and may include a basket support 34 as shown in FIGS. 2 and 3. The basket support 34 is typically constructed of rotomolded plastic and may be designed to hold a strainer basket (not shown). The basket support 34 may be immediately downstream of the inlet pipe 26 and has a cutout 36 to align with the inlet pipe 26. Basket support openings 37 permits the effluent water with fat, oil and grease to flow downstream of the basket support 34 after the solid waste material has been trapped in the strainer basket removably positioned in the support 34.

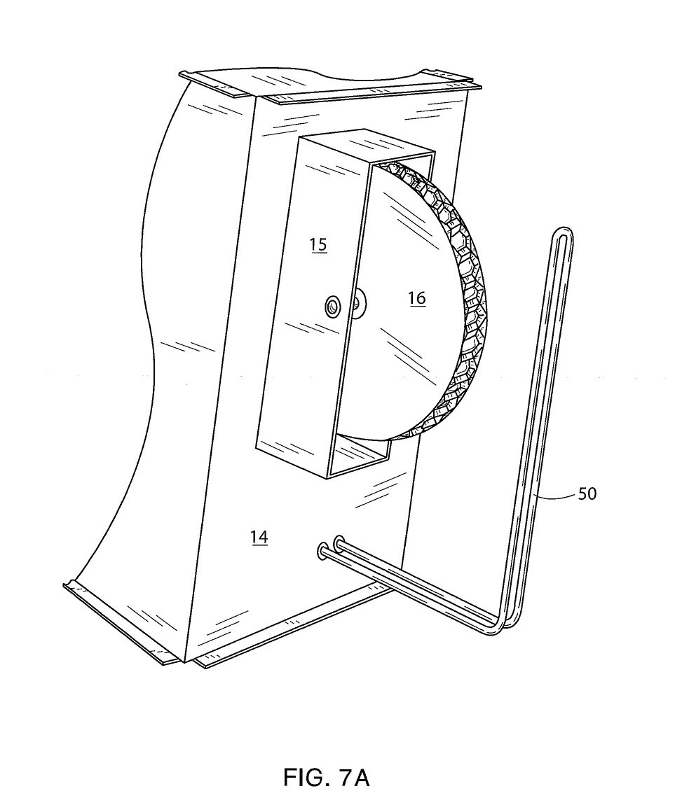

The cover 14b may also support the trough 22, which is generally constructed of stainless steel or in other examples molded plastic. The trough 22 may further include elongated scraper blades 24 which are constructed of a flexible plastic or rubber material. As seen in FIG. 7A, the cover 14b may also support a heating element 50 that extends down into the water held in the container 12 and which is used to maintain a sufficiently warm enough water temperature to melt any grease contained in the grey water, permitting it to flow to and be removed by the rotating disk 16. The heating element 50 is, by way of example, a 450 watt heater.

An oil/grease storage tank (not pictured) may be in communication with the trough 22 in order to receive the F.O.G. which has been scraped from the disk 16 by the scraper blades.

In operation, the fat, oil, grease and/or solid removal assembly 10 is connected to drain from a sink or other device that discharges effluent water with waste materials to be separated. The water containing waste materials flows from the device's drain into the F.O.G. and/or solid removal assembly 10 through the inlet pipe 26. The effluent water flows into the basket support 34 containing a strainer basket and the solid waste materials are trapped and removed from the effluent water. The effluent water containing fat, oil and grease flows downstream from the basket support 34 through openings into the center section of container 12. In the volume of the container 12 between the basket support 34 and an outlet baffle, the effluent has time to reside, permitting fats, oil and grease to rise to the top of the water. The grease is maintained in a liquid state by the heater 50. The heating element also turns on when the thermistor detects a temperature approaching freezing (i.e. 0 degrees Celsius).

When the gear drive motor 20 turns the drive sprocket 38, in the field of FIG. 1, the disk 16 is rotated in a clockwise direction by the counter clockwise rotation of the drive sprocket 38. The disk 16 is positioned in the center cover 14b, so that its lower portion is below the surface of the effluent water having the fat, oil and grease which has floated to the surface. As the disk 16 rotates through the water, F.O.G. is picked up on the sides of the disk 16 and the scraper blades 24 attached to the trough 22 remove the F.O.G. from the sides of the disk 16. The F.O.G. flows down the trough 22 to a F.O.G. storage container. Once the F.O.G. have been removed from the effluent water, the grey water flows downstream under the baffle outlet and exits the F.O.G. removal assembly 10 through the outlet pipe 28 into the sewage system. More examples and details of a F.O.G. removal assembly may be found in U.S. Pat. No. 6,800,195 to Batten et al. and U.S. Pat. No. 7,208,080 to Batten et al. which are both herein incorporated by reference in their entireties. Other types of skimmers can be used in the invention, too, including but not limited to: belt skimmers, examples of which can be seen in U.S. Pat. No. 7,427,356 to Chapin and U.S. Pat. No. 7,296,694 to Weymouth; skimmers that include one or more rotating cylinders that partially or completely submerge, one example as is shown in U.S. Pat. No. 4,051,024 to Lowe et al; skimmers with an absorptive affinity for F.O.G and/or skimmers that include non-cylindrical grease collectors pivoting to come into contact with F.O.G. for removal, one example as seen in U.S. Pat. No. 4,235,726 to Shimko.

In one example, a separator assembly for separating fat, oil, grease and/or solids from effluent includes a container 12 for receiving and holding effluent water containing fat, oil, grease and solid waste to be removed from the effluent water, a rotatable disk 16, a drive 20, a trough 22 and a scraper blade 24. The rotatable disk 16 may be supported in a partially immersed position within the body of effluent water and in contact with the fat, oil and grease. The drive 20 may be in driving engagement to provide rotation of the disk when the drive is engaged. The trough 22 may be mounted in engaging relation to opposite sides of the rotatable disk 16. The scraper blade 24 may be mounted on the trough so that the scraper blade extends from the trough 22 into sliding engagement with a side of the disk 16, the disk, scraper blade 24 and trough 22 cooperatively disposed and structured to direct F.O.G. from the disk along the scraper blade along the trough for collection in a storage tank.

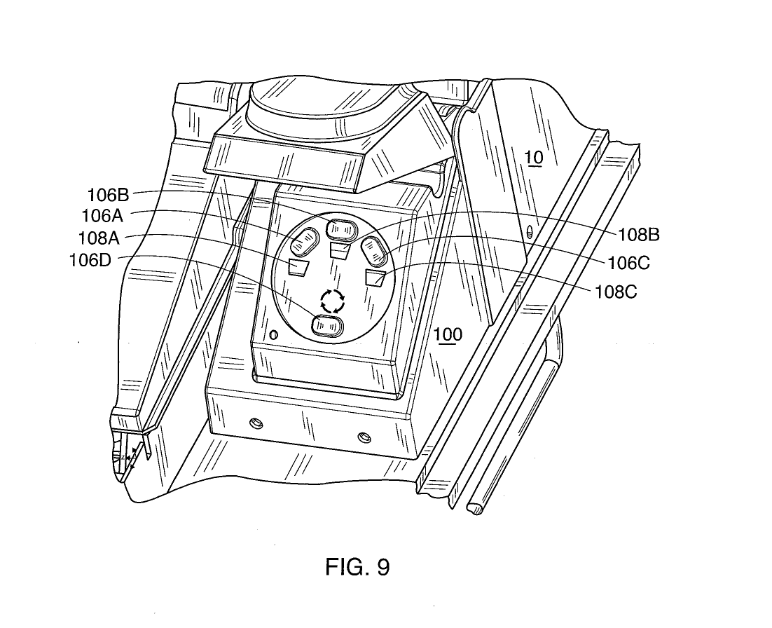

The separator assembly may also include a skimming control 100, as shown in FIGS. 9-12 and 15, that controls when the drive 20 activates rotation of the disk 16 to skim F.O.G. from the effluent. The skimming control 100 may include a preset minimum skim setting above zero, a preset maximum skim setting below a continuous rotation of the disk 16, and a user interface 102 that allows the user to select a skim mode setting between the preset minimum skim setting and the preset maximum skim setting.

Applicant has developed an improved electronic time based control system for F.O.G. separation systems that presets appropriate default levels of skimming operations while still allowing user input based upon facility F.O.G. production. The user is allowed to select between preset default levels so that a continuous, 24 hour a day, 7 days a week, run cycle may not be activated, however, a failure to skim at all is also prevented. In one example, a F.O.G. separation system includes a skimming control 100 including a user interface 102 that allows users to select between preset default levels and/or specialized preset skim cycles.

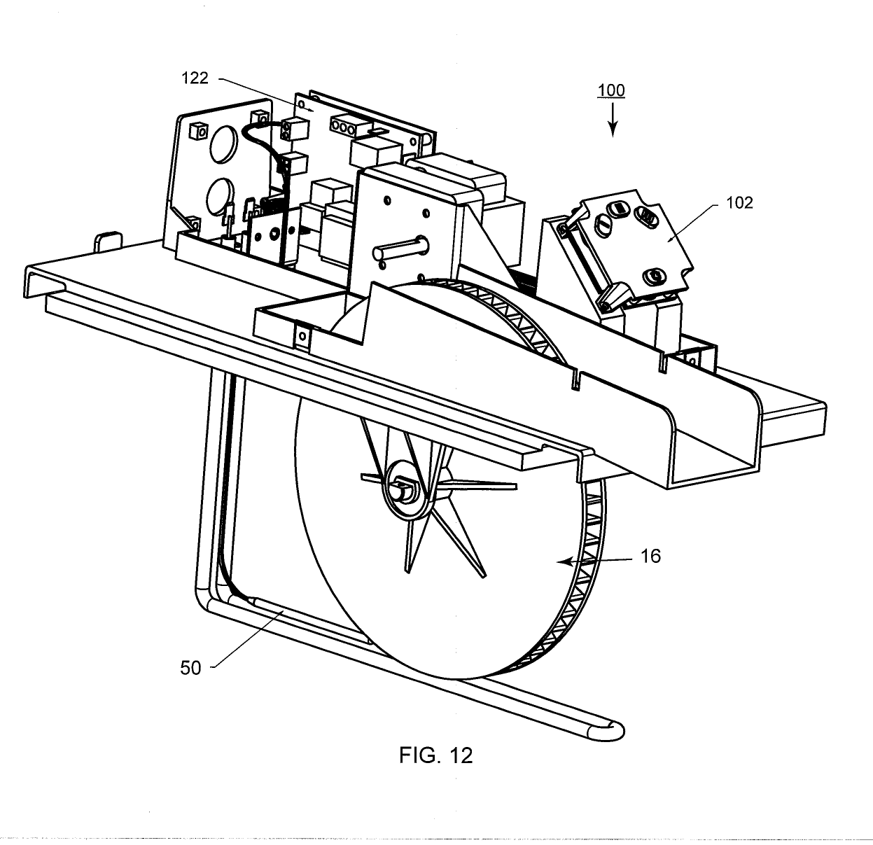

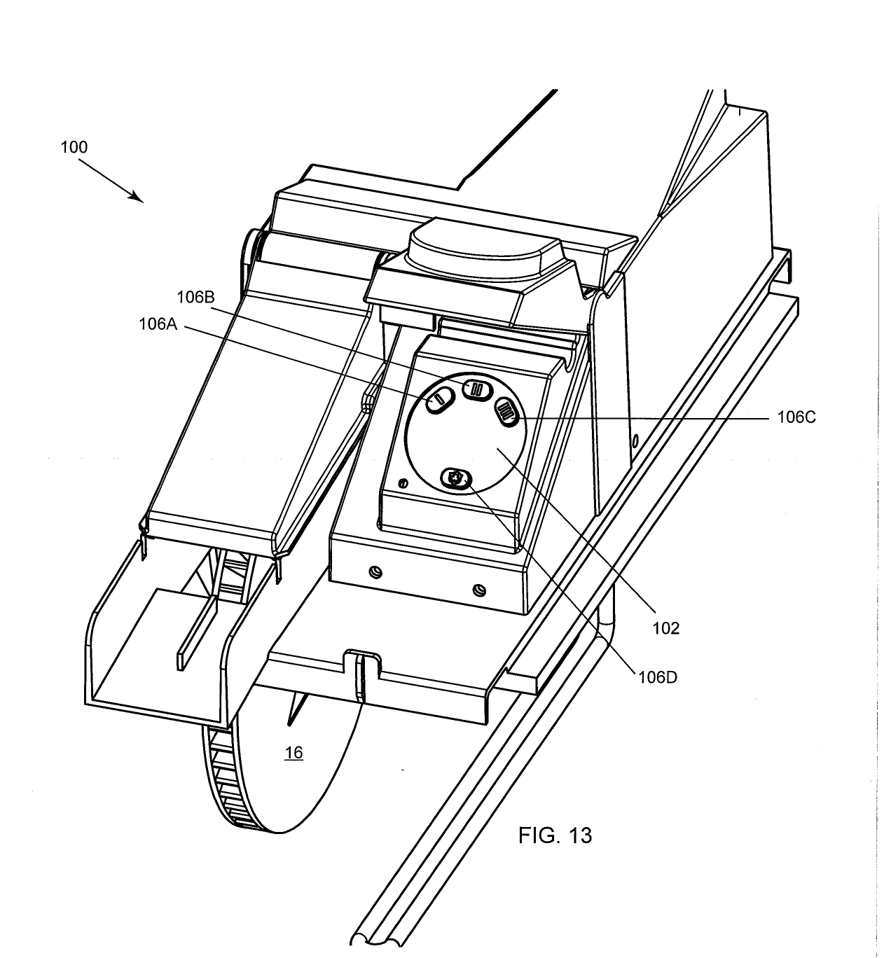

The skimming control 100 may be used with various skimming devices and may include a controller 122 (FIG. 12) and a user interface 102. The user interface 102 may connect with the controller 122, for example with ribbon cable, and may be detachable at a header on the controller 122. Controller may be implemented in electronics on a printed circuit board, ASIC or other electronics. Those of ordinary skill in the art can devise numerous circuits for the control, either hardware-only or with hardware and programming to carry out the processes described herein. In one example, the user interface 102 may include buttons, a keypad, knobs, switches and/or a dial for user input.

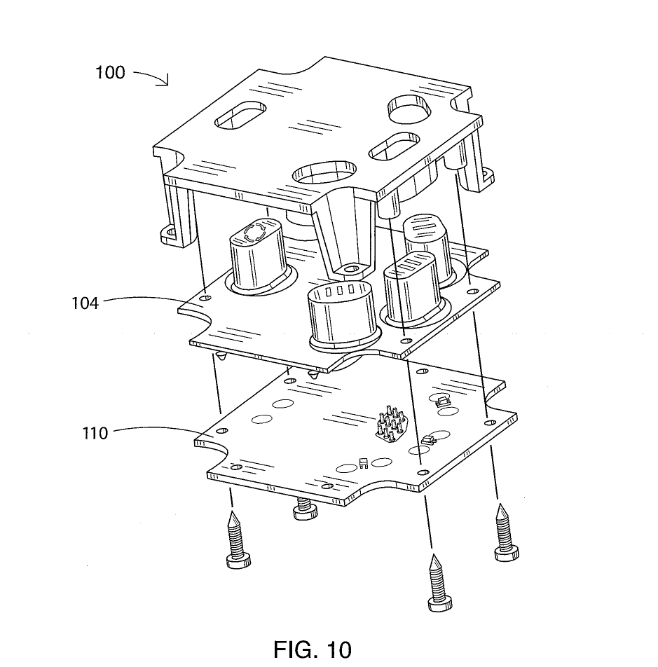

As seen in FIG. 10, a switch membrane 104 may be used as a center element on the skimmer assembly control 100. The switch membrane 104 may be molded from silicone rubber to provide a “seal” over the interface printed circuit board 110, making the interface more water resistant. The individual push button elements are designed to give tactile feedback to the user. Board 110 is electrically connected to controller 122.

By way of example, as shown in FIGS. 9, 12 and 13, the user interface 102 of control 100 may include momentary contact pushbuttons 106A, 106B, 106C and 106D. Buttons 106A-C may represent light, moderate and heavy F.O.G. load button selections, respectively. Button 106D may be a start button. The buttons may be associated with lighted indicators 108A-C that indicate when a particular setting is selected. Pressing the start button 106D may cause the skimmer control 100 to run the motor while depressed. The start button 106D may also be programmed to initiate an on-demand limited skim. Pressing and releasing the start button 106D may activate the skimmer to run for a preset period of time and/or may cause the skimmer to run while the start button is depressed.

Typically, the cycles are preprogramed into the skimmer control 100 and generally involve default programming for a light, moderate and heavy F.O.G. cycles for normal facility operations. The default programming, by way of example, may include programming as demonstrated below:

Default Level - Normal Operation

| Button Selected | Skim Time | Delay between Skims* |
|---|---|---|
| Light (L) | 15 Minute | 76 hours |
| Moderate (M) | 30 Minutes | 19 Hours |
| Heavy (H) | 60 Minutes | 19 Hours |

In addition to default skimming programed levels, there may also be other pre-programmed specialized skim levels or cycles. In one example, there may be a mode for facilities producing heavier amounts of F.O.G. than is typical for an average facility. Such a mode may include a light, moderate and heavy user selection option for extreme F.O.G. production option. An example of the preprogrammed operation levels may be as outlined below:

Extreme Level - Normal operation

| Button Selected | Skim Time | Delay between Skims* |
|---|---|---|
| Light (L) | 90 Minute | 19 hours |
| Moderate (M) | 120 Minutes | 19 Hours |
| Heavy (H) | 120 Minutes | 9.5 Hours |

*Delay between Skims is the time from the start of the 1st skim to the start of the next skim.

Specific modes tailored to specific facility operations may also be included. For example, various presets may be included for a facility operating a rotisserie. Rotisseries, particularly for chicken, are known to generate heavy F.O.G. loads, as disclosed in the teachings of U.S. Pat. No. 6,213,002 to Batten et al., the disclosure of which is incorporated herein by reference. These specific presets could also include a default level and/or an extreme level setting, among others, as seen below:

Default Level - Rotisserie Operation

| Button Selected | Skim Time | Delay between Skims* |
|---|---|---|
| Light (L) | 30 Minute | 6 hours |
| Moderate (M) | 60 Minutes | 6 Hours |
| Heavy (H) | 90 Minutes | 6 Hours |

*Delay between Skims is the time from the start of the 1st skim to the start of the next skim.

Extreme Level - Rotisserie Operation

| Button Selected | Skim Time | Delay between Skims* |
|---|---|---|
| Light (L) | 30 Minute | 2 hours |
| Moderate (M) | 60 Minutes | 2 Hours |
| Heavy (H) | 90 Minutes | 2 Hours |

*Delay between Skims is the time from the start of the 1st skim to the start of the next skim.

In some examples, the facility operator is allowed user input into the skimming cycles based upon their facility operations. The operator may choose a Light cycle by pressing button A, a Moderate cycle by pressing button B or a Heavy cycle by pressing button C. Cycle times are, however, pre-selected and controlled so that constant skimming is not among the presets. Nor, preferably is a zero-skimming option among the presets, although a null preset, discussed below, can be considered for periods when there will be extended periods of no F.O.G. flow. Preferably, also not present is a preset that would make the skimming operation occur at a consistent time of day, for example, every other day at 2:00 PM. A preferred schedule is seemingly random, so the skimming event seems to observers at differing times on differing days. That is the period of delay between the initiations of skimming events is set to that observers do not perceive a regular schedule.

In some examples, the pre-programmed skim cycle may direct a skimming event to occur at non-repetitive times over the course of a given time period. For example, a pre-programmed skim cycle may direct skimming events to occur at a non-repetitive time during consecutive skimming events. In another example, a pre-programmed skimming cycle may direct skimming events to occur at a non-repetitive time during a 48 hour, 72 hour or week time period, etc.

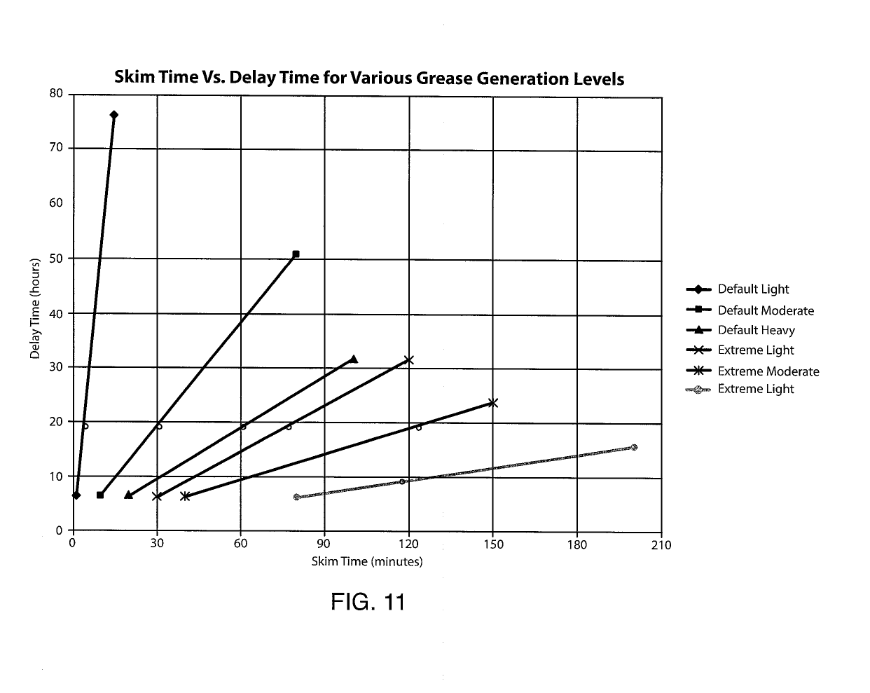

In one example, the user skim mode settings may direct skim cycles based upon ratios of “skim periods” to “delay periods.” As seen in FIG. 11, Applicant established a relationship between skim periods and delay periods so that pre-set operation levels may be pre-programmed based upon the amount of F.O.G. a facility produces. As grease production increases at a facility, skim period increases relative to the delay period. FIG. 11 shows selected skim/delay ratios that can be made available to users as presets (that is, the user can select one of the noted schedules by depressing one of the pushbuttons 106A, 106B, 106C or 106D). As seen in the examples shown in FIG. 11, skim times for the default light setting could vary between approximately a couple of minutes to just over fifteen minutes based upon the delay interval chosen. The skim/delay times along this time line result in the same skim operation results by fluctuating one of the variables. The default moderate skim time could be set, for example, at approximately just under 15 minutes and/or up to almost 90 minutes, depending on a skim time delay selection of between 5 hours to two days. Other example cycles are represented in FIG. 11.

In another example, Applicant desired a skimming schedule that would result in the most non-repetitive skim times. Applicant discovered that 19 hour skim cycle delays (or multiples thereof) occurred along the skim/delay schedules and produced substantially non-repetitive skim times for facilities with light and moderate F.O.G. production. Skimming events occurred the most randomized (seemingly) when scheduled with 19 hour delay times in between skimming events. This caused skimming events to be perceived as happening randomly at different times of day and/or different days of the week, even though they are regularly scheduled. In other examples, prime numbers of hours (and/or minutes) may be used in setting delay times.

In some instances, when very low amounts of F.O.G. is produced at a facility and there is a lower skim setting selected, there may be an exercise cycle preprogramed where the control runs the motor for a short period of time to exercise the motor. The skimming is controlled by the control 100 and generally time based. The control 100 may also have a “Null” mode, which can be set manually with another push button, not shown, much like the skim frequency (L, M, H) is set. If the unit is in the “Null” mode, the board will not turn “on” the motor for skimming, but will still exercise the motor for a very short duration sec.) This technique is controlled by program stored for the controller.

In some examples, a thermistor 50 is in communication with the controller 122 (see FIGS. 12 and 13). The thermistor and controller are able to measure temperature. For example, in a rotisserie mode, a change in temperature may trigger a skimming event. By way of example, when a rotisserie cooking session is completed, a fairly large volume of hot grease and hot water may be released from the rotisserie oven. When this “dump” takes place, the container has a rather significant fresh charge of grease that is ready to be skimmed. The thermistor may detect a sudden change in temperature from the fresh volume of hot fluid and begin a rotisserie skim cycle. Skim duration is typically time based. In other examples, temperature within the F.O.G. separation system may be measured with a thermocouple based device. In rotisserie type cycles, the preprogramed cycle option may include a setting where skimming is activated when a preset temperature or temperature variation is sensed.

By way of example, a user may toggle between default modes, extreme modes and/or specific facility modes by using a pre-set activation code. The activation code may include pressing buttons in a particular series. The activation code may also include a power down and/or power up of the separator assembly. By including an activation code to toggle between modes, the same buttons may be used for different preprogrammed cycle setting levels.

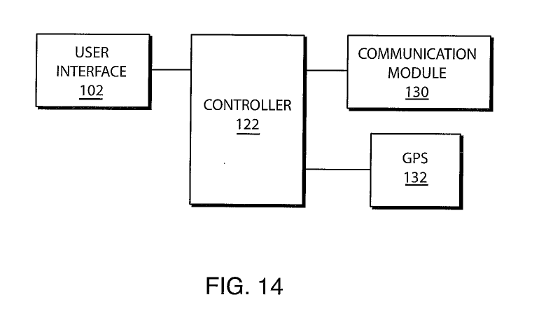

As seen in FIG. 14, the controller 122 is connected to a communications module 130 and a Global Positioning System (GPS) module 132. The module 130 has communications capabilities such as a cellphone or Wi-Fi connection and can relay messages from the controller 122. Information about the geographic location of the F.O.G. separator can be ascertained by the GPS module 132 for use by the controller 122 and/or relayed by the communications module 130. The controller may permit cellphone or other communications operation to report a malfunction and/or need for a service call. In addition, the communications capability can be operated with a GPS receiver or the like can help a service technician locate where the unit it is. Also, a central office can be informed of the selected mode or skimming frequency, so the central office can recommend or implement changes if it does not think mode setting is appropriate for the specific establishment. The communications capability can report cumulative operating time to allow recommendations for replacement parts for preventative maintenance.

Also disclosed is a method of controlling removal of grease, oil and solid waste material from effluent water including: installing an oil, grease and solid waste removal assembly at a facility site; connecting an inlet pipe of the oil, grease and solid waste removal assembly to a source discharging effluent water with waste materials to be removed; connecting an outlet pipe of the oil, grease assembly to a sewage system; installing a strainer basket in the assembly; installing an oil and grease storage container to receive oil and grease flow from a trough in the assembly; engaging a drive motor of the assembly to rotate a disk in the assembly to remove oil and grease from effluent water; and controlling the drive motor with a skimming control that controls when the drive activates rotation of the disk to skim F.O.G. from the effluent. The skimming control includes a preset minimum skim setting above zero, a preset maximum skim setting below a continuous rotation of the disk, and a user interface that allows the user to select a skim mode setting between the preset minimum skim setting and the preset maximum skim setting. The method may also include programming the user skim mode settings to include an active skim time variable and a delay between the skim times variable that minimize the number of skims at the same time of day from one day to the next.

In another example, a method of making a F.O.G. removal assembly includes: rotomolding a container having inlet and outlet ends, a strainer basket support, an outlet baffle and a cover for the container, securing the strainer basket support within the container, securing the outlet baffle within the outlet end of the container, installing a F.O.G. removal skimmer assembly to the container, the assembly having a rotatable disk and a drive to provide rotation of the disk when the drive is engaged, and installing a skimming control that controls when the drive activates rotation of the disk to skim F.O.G. from the effluent. The skimming control includes: a preset minimum skim setting above zero, a preset maximum skim setting below a continuous rotation of the disk, and a user interface that allows the user to select a skim mode setting between the preset minimum skim setting and the preset maximum skim setting. The method may also include programming the skim mode setting to minimize the number of skims at the same time of day from one day to the next.

Rotomolding is the preferred fabrication method for the several components because of its low cost, however, other materials are considered within the scope of this disclosure.

Certain modifications and improvements will occur to those skilled in the art upon reading the foregoing description. It should be understood that all such modifications and improvements have been omitted for the sake of conciseness and readability, but are properly within the scope of the following claims.

What is claimed is:

1. A separator assembly for separating fat, oil, and grease from effluent comprising:
a container with a cover for receiving and holding effluent water containing oil, grease and solid waste to be removed from the effluent water;
at least one rotatable disk supported within the container in a partially immersed position within the body of effluent water and in contact with the oil and grease;
a drive mounted in driving engagement to provide rotation of the disk when the drive is engaged;
a trough mounted in engaging relation to opposite sides of the rotatable disk;
a scraper blade mounted on the trough so that the scraper blade extends from the trough into sliding engagement with a side of the disk, the disk, scraper blade and trough cooperatively disposed and structured to direct oil and grease from the disk along the scraper blade along the trough for collection in a storage container;
a skimming control that controls when the drive activates rotation of the disk to skim F.O.G. from the effluent, the skimming control having:
a preset minimum skim setting above zero,
a preset maximum skim setting below a continuous rotation of the disk, and
a user interface that allows the user to select a user skim mode setting between the preset minimum skim setting and the preset maximum skim setting.

2. The separator of claim 1, wherein the user skim mode setting includes a pre-programmed skim cycle.

3. The separator of claim 2 wherein the pre-programmed skim cycle directs a skimming event to occur at a non-repetitive time during consecutive skimming events.

4. The separator of claim 2 wherein the user skim mode setting allows selection of a skim cycle based upon a facility's F.O.G. production.

5. The separator of claim 4 wherein the user skim mode setting is a default setting.

6. The separator of claim 2 wherein the user skim mode setting directs skim cycles based upon ratios of skim period to delay period.

7. The separator of claim 2 wherein the user skim mode setting includes an active skim time variable and a delay between the skim times variable.

8. The separator of claim 7 wherein the delay between skim times variable is a prime number of hours.

9. The separator of claim 8 wherein the delay between skim times variable is 19 hours.

10. The separator of claim 7 wherein the delay between skim times variable does not allow skim times to occur at the same time of day during a week-long skimming schedule.

11. The separator of claim 2 wherein the user interface includes a user input device for selecting the user skim mode setting.

12. The separator of claim 11 wherein the user input device includes a silicone switch membrane.

13. The separator of claim 1 wherein the skimming control has a null mode that does not skim, but periodically exercises a motor of the drive for a brief period.

14. The separator of claim 1 wherein the control is in communication with a GPS module to allow determination of the geographic location of the separator assembly.

15. The separator of claim 1 wherein the control is in communication with communication module to permit remote communications.

16. The separator of claim 2 wherein the container includes a heating element.

17. The separator of claim 16 wherein the heating element is a 450 watt heater with a quick reaction thermostat.

18. The separator of claim 2 wherein the skimming control includes a timer.

19. A skimmer control system for a F.O.G. separator that removes F.O.G. from effluent, comprising:
a skimming control that controls when a skimming event occurs to skim F.O.G. from the effluent, the skimming control having:
a preset minimum skim setting above zero,
a preset maximum skim setting below a continuous skim event, and
a user interface that allows the user to select a user skim mode setting between the preset minimum skim setting and the preset maximum skim setting,
wherein the user skim mode settings include a programming cycle that directs a series of skimming events to occur at substantially non-repetitive times during a skimming event cycle.

20. The separator of claim 19 wherein the user skim mode settings include a programming cycle that directs a skimming event to occur at a non-repetitive time during consecutive skimming events.

21. The skimmer control for the F.O.G. separator of claim 19 including a user interface that allows the user to select a user skim mode setting between the preset minimum skim setting and the preset maximum skim setting based upon a facility's F.O.G. production.

22. The skimmer control for the F.O.G. separator of claim 19 wherein the user skim mode settings direct skim cycles based upon a ratio of skim period to delay period.

23. The skimmer control for the F.O.G. separator of claim 19 wherein the skim mode settings include a skim period and a delay period that minimize the number of skims at the same time of day from one day to the next.

24. The skimmer control for the F.O.G. separator of claim 19 wherein the user skim mode settings include an active skim time variable and a delay between the skim times variable.

24. The skimmer control for the F.O.G. separator of claim 19 wherein the control has a null mode that does not skim, but periodically exercises a motor of the drive for a brief period.

26. The skimmer control for the F.O.G. separator of claim 19 wherein the control is in communication with a GPS module to allow determination of the geographic location of the separator assembly and the control is in communication with communication module to permit remote communications.

27. A method of controlling removal of grease, oil and solid waste material from effluent water comprising:
installing an oil, grease and solid waste removal assembly at a facility site;
connecting an inlet pipe of the oil, grease and solid waste removal assembly to a source discharging effluent water with waste materials to be removed;
connecting an outlet pipe of the oil, grease assembly to a sewage system;
installing an oil and grease storage container to receive oil and grease flow from a trough in the assembly;
engaging a drive motor of the assembly to rotate a disk in the assembly to remove oil and grease from effluent water;
controlling the drive motor with a skimming control that controls when the drive activates rotation of the disk to skim F.O.G. from the effluent, the skimming control having:
a preset minimum skim setting above zero,
a preset maximum skim setting below a continuous rotation of the disk, and
a user interface that allows the user to select a skim mode setting between the preset minimum skim setting and the preset maximum skim setting.

28. The method of claim 27 including programming the user skim mode settings to include an active skim time period and a delay-between-skims period that minimize the number of skims at the same time of day from one day to the next.

29. A method of making a F.O.G. removal assembly comprising:
rotomolding a container having inlet and outlet ends, a strainer basket support, an outlet baffle and a cover for the container,
securing the strainer basket support within the container,
securing the outlet baffle within the outlet end of the container,
installing a F.O.G. removal skimmer assembly that has a rotatable disk and a drive to provide rotation of the disk when the drive is engaged and a skimming control that controls when the drive activates rotation of the disk to skim F.O.G. from the effluent, the skimming control having:
a preset minimum skim setting above zero,
a preset maximum skim setting below a continuous rotation of the disk, and
a user interface that allows the user to select a skim mode setting between the preset minimum skim setting and the preset maximum skim setting.

30. The method of claim 29 including programming the skim mode setting to minimize the number of skims at the same time of day from one day to the next.

31. A method of controlling a skimming event for a F.O.G. separator that removes F.O.G. from effluent, comprising:
programming a skimming control that controls when a skimming event occurs to skim F.O.G. from the effluent, the skimming control having a preset minimum skim setting above zero in the control and a preset maximum skim setting below a continuous skim event in the control, and
providing a user interface that allows the user to select a user skim mode setting between the preset minimum skim setting and the preset maximum skim setting, wherein the user skim mode settings include a programming cycle that directs a series of skimming events to occur at substantially non-repetitive times during a skimming event cycle.

32. A separator assembly for separating fat, oil, and grease (F.O.G.) from effluent comprising:
a container for receiving and holding effluent water containing F.O.G. to be removed from the effluent water;
a skimmer within the container in a partially immersed position within the body of effluent water and in contact with the F.O.G. and configured to remove F.O.G and direct it to a storage container;
a skimming control that controls when the skimmer is active, the skimming control having:
a preset minimum skim setting above zero,
a preset maximum skim setting below a continuous rotation of the disk, and
a user interface that allows the user to select a skim mode setting between the preset minimum skim setting and the preset maximum skim setting.
